(19) United States
(12) Patent Application Publication
(10) Pub. No.: US 2011/0299166 A1
(43) Pub. Date: Dec. 8, 2011

(54) Thermally Tunable Optical Filter with Single Crystalline Spacer Fabricated by Fusion Bonding

(75) Inventor: Rong Sun, Cambridge, MA (US)

(73) Assignee: AEGIS LIGHTWAVE, INC., Woburn, MA (US)

(21) Appl. No.: 13/154,262

(22) Filed: Jun. 6, 2011

Related U.S. Application Data
(60) Provisional application No. 61/352,238, filed on Jun. 7, 2010.

(51) Int. Cl. G02B 26/00; B32B 37/00

(52) U.S. Cl. 359/579; 156/182

(57) ABSTRACT

A thermally tunable Fabry-Perot optical filter includes a single crystalline sheet resistance heater layer. A single crystalline semiconductor spacer layer is positioned proximate to and in thermal communication with the single crystalline sheet resistance heater layer. A first distributed Bragg reflector is positioned proximate to a first surface of the single crystalline semiconductor spacer layer. A second distributed Bragg reflector is positioned proximate to a second surface of the single crystalline semiconductor spacer layer.

### CROSS-REFERENCE TO RELATED APPLICATIONS

The present application is a non-provisional of copending U.S. Provisional Patent Application Ser. No. 61/352,238, filed on Jun. 7, 2010. The entire contents U.S. Patent Application Ser. No. 61/352,238 is herein incorporated by reference.

The section headings used herein are for organizational purposes only and should not to be construed as limiting the subject matter described in the present application in any way.

### INTRODUCTION

Optical filters are commonly used in a wide variety of applications. For example optical filters are commonly used in the optical communications field to separate optical channels in optical fiber networks. Many optical filters are formed from thin films that reflect or transmit a narrow band of wavelengths. Tunable optical filters are designed to change the narrow band of wavelengths that is reflected or transmitted. For example, some tunable optical filters are thermo-optically tunable.

Many known thermo-optically tunable thin film filters include a single cavity Fabry-Perot type filter. Some thermo-optically tunable, thin-film optical filters are formed of amorphous semiconductor silicon, which has a large thermo-optic coefficient. The Fabry-Perot cavity includes a pair of thin film multi-layer interference mirrors that are separated by a spacer. The thin film mirrors include alternating quarter wave pairs of high and low index films. To produce more complex pass band characteristics or more well defined pass bands, multiple cavities can be concatenated to form a multi-cavity structure.

Thermo-optically tunable thin film filters are characterized by a pass band centered at a wavelength that is controlled by the temperature of the device. In other words, by changing the temperature of the filter one can shift the location of the pass band back-and-forth over a range of wavelengths and thereby control the wavelength of the light that is permitted to pass through (or be reflected by) the device.

### BRIEF DESCRIPTION OF THE DRAWINGS

The applicant's teachings, in accordance with preferred and exemplary embodiments, together with further advantages thereof, is more particularly described in the following detailed description, taken in conjunction with the accompanying drawings. The skilled person in the art will understand that the drawings, described below, are for illustration purposes only. The drawings are not necessarily to scale, emphasis instead generally being placed upon illustrating principles of the teachings. The drawings are not intended to limit the scope of the applicant's teachings in any way.

FIG. 1A illustrates one embodiment of a thermally tunable Fabry-Perot optical filter with a single-crystalline semiconductor cavity according to the present teaching.

FIG. 1B illustrates another embodiment of a thermally tunable Fabry-Perot optical filter with a single-crystalline semiconductor cavity according to the present teaching.

FIG. 1C illustrates yet another embodiment of a thermally tunable Fabry-Perot optical filter with a single-crystalline semiconductor cavity according to the present teaching where a single crystalline heater is positioned co-planar to the semiconductor cavity.

FIG. 2A illustrates a process for fabricating the thermally tunable Fabry-Perot optical filter with the single-crystalline silicon cavity that was described in connection with FIG. 1A.

FIG. 2B illustrates another process for fabricating the thermally tunable Fabry-Perot optical filter with the single-crystalline silicon cavity that was described in connection with FIG. 1A.

FIG. 2C illustrates another process for fabricating the thermally tunable Fabry-Perot optical filter with the single-crystalline silicon cavity that was described in connection with FIG. 1A.

FIG. 3A illustrates a process for fabricating the thermally tunable Fabry-Perot optical filter with the single-crystalline silicon cavity that was described in connection with FIG. 1B.

FIG. 3B illustrates another process for fabricating the thermally tunable Fabry-Perot optical filter with the single-crystalline silicon cavity that was described in connection with FIG. 1B.

### DESCRIPTION OF VARIOUS EMBODIMENTS

Reference in the specification to “one embodiment” or “an embodiment” means that a particular feature, structure, or characteristic described in connection with the embodiment is included in at least one embodiment of the teaching. The appearances of the phrase “in one embodiment” in various places in the specification are not necessarily all referring to the same embodiment.

It should be understood that the individual steps of the methods of the applicant's teachings may be performed in any order and/or simultaneously as long as the teachings remain operable. Furthermore, it should be understood that the apparatus and methods of the applicant's teachings can include any number or all of the described embodiments as long as the teachings remain operable.

The applicant's teachings will now be described in more detail with reference to exemplary embodiments thereof as shown in the accompanying drawings. While the applicant's teachings are described in conjunction with various embodiments and examples, it is not intended that the applicant's teachings be limited to such embodiments. On the contrary, the applicant's teachings encompass various alternatives, modifications and equivalents, as will be appreciated by those of skill in the art. Those of ordinary skill in the art having access to the teaching herein will recognize additional implementations, modifications, and embodiments, as well as other fields of use, which are within the scope of the present disclosure as described herein.

The present teaching relates to highly reliable thermally tunable Fabry-Perot optical filters that include a single crystalline sheet resistance heater layer, a thin single crystalline semiconductor (or other crystalline material) or polymer spacer that forms a cavity, and distributed Bragg reflectors having layers of dielectric materials. Numerous types of single crystalline semiconductor spacer layers can be used, such as a (c-Si) silicon, Ge, III-V semiconductor, and II-VI semiconductor. There are many advantages of fabricating tunable optical filters with a single crystal semiconductor cavity. One advantage is that single crystal semiconductor cavities are very low loss compared with amorphous material cavities in the wavelength ranges used for optical communications, such as the 1550 nm wavelength. Therefore, single crystal semiconductor cavities have high optical transparency at these wavelengths. Another advantage is that tunable optical filters with single-crystalline semiconductor cavities have a wide thermal tuning range due to their relatively high thermal optic coefficient. Another advantage is that tunable optical filters with single-crystalline semiconductor cavities have high thermal stability so they can be used in various fabrication processes. Yet another advantage is that the thickness of the single crystalline semiconductor cavities can vary over a much greater range compared with amorphous silicon cavities in known optical filters. Therefore, filter parameters can be easily varied.

The filters and methods of fabricating filters according to the present invention are described with single crystalline silicon cavities. However, one skilled in the art will appreciate that the filters and methods of fabricating filters according to the present teaching can include numerous other types of cavity materials, such as single crystalline germanium, single crystalline III-V semiconductor, single crystalline II-VI semiconductor, thermal oxide, and other optical materials that will be stable at the processing and bonding temperatures. Also, one skilled in the art will appreciate that the methods of fabricating filters according to the present teaching can be used to fabricate double cavity and other multicavity filters.

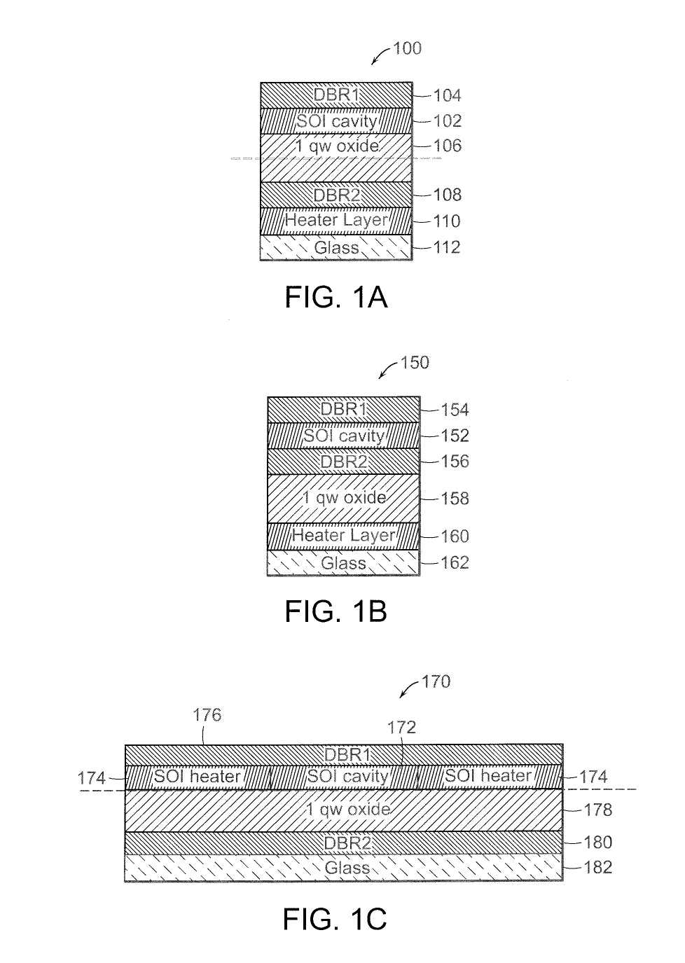

FIG. 1A illustrates one embodiment of a thermally tunable Fabry-Perot optical filter 100 with a single-crystalline semiconductor cavity according to the present teaching. The tunable optical filter 100 includes a single-crystalline semiconductor cavity 102, such as a silicon cavity. A first distributed Bragg reflector 104 is formed on a top surface of the single-crystalline silicon cavity 102. A quarter-wavelength oxide layer 106 is formed on the bottom surface of the single-crystalline silicon cavity 102 by fusion bonding the two halves of the tunable optical filter 100 as described below. A second distributed Bragg reflector 108 is formed on the bottom surface of the quarter wavelength oxide layer 106. A single crystalline heater 110 is formed on the bottom of the second distributed Bragg reflector 108. An electrical contact is made to the crystalline heater 110. A glass substrate 112 is bonded to the single crystalline heater 110.

FIG. 1B illustrates another embodiment of a thermally tunable Fabry-Perot optical filter 150 with a single-crystalline semiconductor cavity according to the present teaching. The tunable optical filter 150 is similar to the tunable optical filter 100 that was described in connection with FIG. 1A. The tunable optical filter 150 also includes a single-crystalline semiconductor cavity, such as a silicon cavity 152. However, both the first 154 and second distributed Bragg reflector 156 are directly adjacent to the single-crystalline silicon cavity 152. The first distributed Bragg reflector 154 is formed on a top surface of the single-crystalline silicon cavity 152. The second distributed Bragg reflector 154 is formed on a bottom surface of the single-crystalline silicon cavity 156. A quarter wavelength oxide layer 158 is formed on the bottom surface of the second distributed Bragg reflector 156 by fusion bonding two halves of the tunable optical filter 150 as described below. A single crystalline heater 160 is formed on the bottom of the quarter wavelength oxide layer 158. An electrical contact is made to the crystalline heater 160. A glass substrate 162 is bonded to the single crystalline heater 160.

FIG. 1C illustrates another embodiment of a thermally tunable Fabry-Perot optical filter 170 with a single-crystalline silicon cavity 172 according to the present teaching where single crystalline heaters 174 are positioned co-planar to the silicon cavity 172. The tunable optical filter 170 is similar to the tunable optical filter 100 that was described in connection with FIG. 1A. However, single crystalline heaters 174 are positioned adjacent to the silicon cavity 172 in a co-planar arrangement. The first distributed Bragg reflector 176 is formed on a top surface of the co-planar single-crystalline silicon cavity 172 and the single crystalline heaters 174. A quarter wavelength oxide layer 178 is formed on the bottom surface of the co-planar single-crystalline silicon cavity 172 and the single crystalline heaters 174. A second distributed Bragg reflector 180 is formed on the quarter wavelength oxide layer 178. The filter 170 can be fabricated on a glass substrate 182 as shown in FIG. 1C.

The co-planar single-crystalline silicon cavity 172 and single crystalline heaters 174 can be integrated into the same layer by selective doping the single crystalline material. The selective doping changes the resistance of the single crystalline heater portions of the layer so that these portions become resistive heaters. Heat generated by the single crystalline heater portions of the layer flows in the plane of the cavity so as to thermally tune the index of refraction of the active region of the cavity.

One skilled in the art will appreciate that there are many other possible configurations of the thermally tunable Fabry-Perot optical filters according to the present teaching that include single crystalline heaters and single-crystalline semiconductor, other crystalline materials, or polymer cavities.

It is desirable for the thermally tunable Fabry-Perot optical filters according to the present teaching to use cavities formed of materials having relatively high thermo-optical coefficient. High thermal-optic coefficient materials will have a relatively large change in refractive index as a function of temperature. One type of suitable single-crystalline cavity material is single crystalline silicon. Single crystal silicon has a thermal optical coefficient that is equal to 1.90E-04 (dn/dT) at 20 degree C. when filtering a 1550 nm optical signal. Single crystal silicon is desirable because it is relatively inexpensive and easy to process and it is easy to integrate into the filter. Another suitable single-crystalline cavity material is single crystal germanium, which has a thermal optical coefficient that is equal to 5.80E-04 (dn/dT) at 20 degree C. when filtering a 1550 nm optical signal. Another suitable single-crystalline cavity material is indium phosphide, which has a thermal optical coefficient that is equal to 2.00E-04 (dn/dT) at 20 degree C. when filtering a 1550 nm optical signal. Yet another suitable single-crystalline cavity material is single crystal gallium arsenide, which has a thermal optical coefficient that is equal to 2.35E-04 (dn/dT) at 20 degree C. when filtering a 1550 nm optical signal.

In addition, it is desirable for the thermally tunable Fabry-Perot optical filters according to the present teaching to use cavities formed of materials having relatively high thermal stability. Some fabrication processes according to the present teaching require good thermal stability at temperatures in the 500 degrees C. range to perform fusion bonding and deposition processes. Furthermore, thermally tunable Fabry-Perot optical filters according to the present teaching have relatively high optical transparency at the wavelength being processed by the filter. For example, for filters intending to filter 1550 nm optical signal commonly used in optical communication systems, a relatively high transparency is desirable around 1.5 um.

Single crystal semiconductor material are desirable cavity materials because they typically are highly transparent at the wavelength of the optical signal being filtered and they have high thermal stability at process temperatures used in the fabrication methods of the present teaching. The present invention, however, is not limited to filters with single crystal semiconductor cavities. Numerous other cavity materials with relatively high thermal optical coefficients, relatively high thermal stability at processing temperatures, and relatively high optical transparency at the wavelength being processed by the filter can be used. For example, high temperature polymers can be used that have these material properties. Many polymers have large thermo-optic coefficients. Recently polymers, such as high temperature polyimides, have been developed that have good thermal stability at the required processing temperatures.

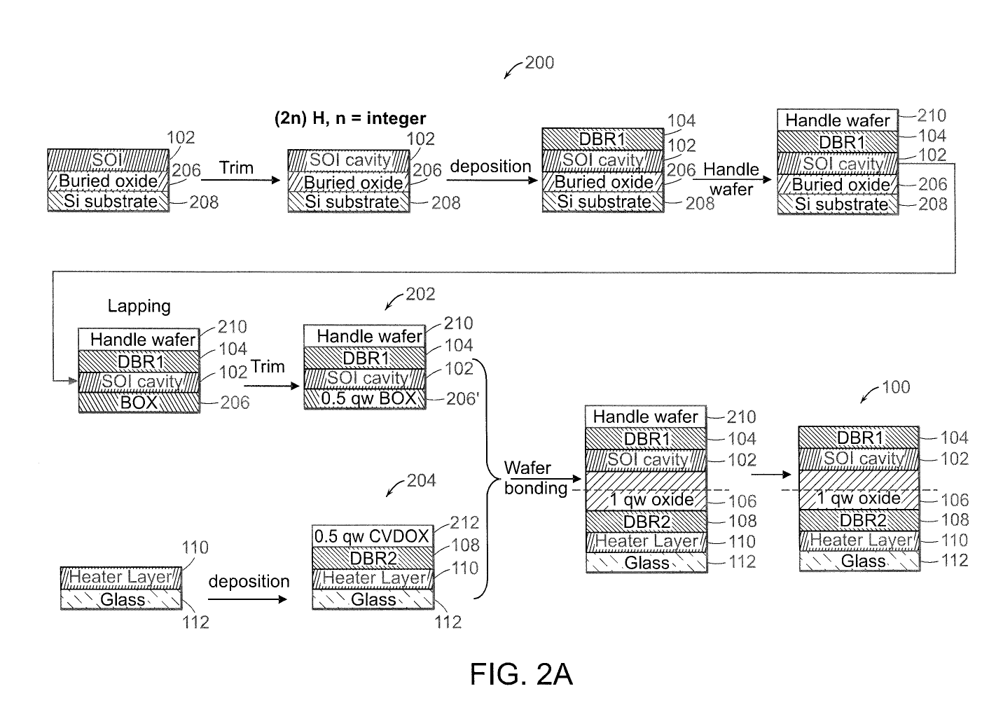

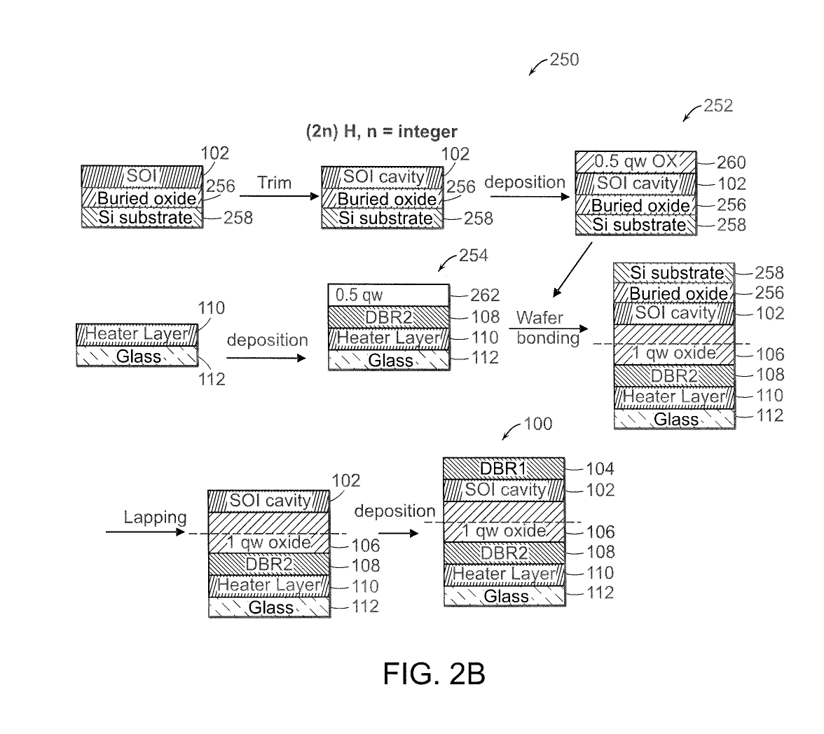

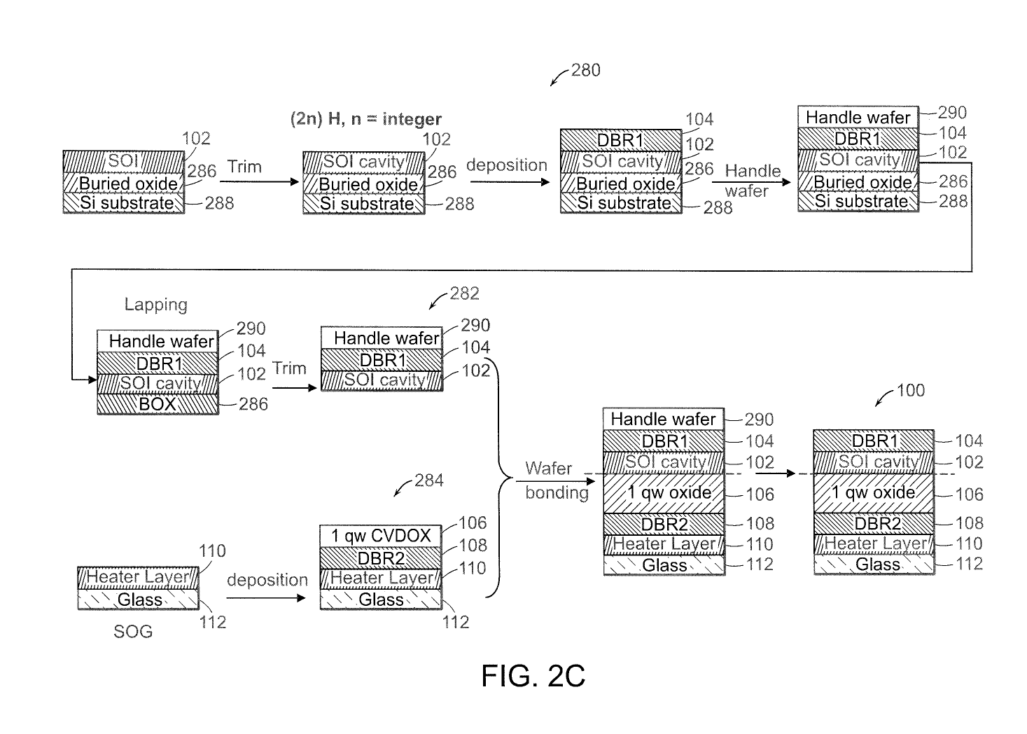

FIG. 2A illustrates a process 200 for fabricating the thermally tunable Fabry-Perot optical filter 100 with the single-crystalline silicon cavity 102 that was described in connection with FIG. 1A. Referring to both FIGS. 1A and 2A, the single-crystalline silicon cavity 102 and the first distributed Bragg reflector 104 are formed on a first half 202 of the tunable optical filter 100 and the single crystalline heater 110 and the second distributed Bragg reflector 108 are formed on a second half 204 of the tunable optical filter 100. The first 202 and the second half 204 of the thermally tunable Fabry-Perot optical filter 100 are then fusion bonded together at high temperature and high pressure.

More specifically, the first half 202 of the tunable optical filter 100 is formed by providing a silicon substrate 208 with a buried oxide layer 206 and a single crystal silicon layer. The single-crystalline silicon layer forms the cavity 102. The thickness and uniformity of the single crystal silicon needs to be precisely controlled over the entire wafer because the thickness controls the resonant frequency of the tunable optical filter. Dry/wet oxidation can be used to trim the thickness of the silicon to larger than 100 nm over the entire wafer in any of the methods of the present teaching. Chemical etching can be used to controllably remove as little as 2 nm of silicon at a time in any of the methods of the present teaching.

The first distributed Bragg reflector 104 is then deposited on top of the single-crystalline silicon cavity 102. The first distributed Bragg reflector 104 is formed of dielectric materials that will be stable during the high temperature fusion bonding process. For example, the first distributed Bragg reflector 104 can be formed of alternating layers of silicon oxide, silicon nitride, and silicon oxynitride. Physical vapor deposition (PVD) or chemical vapor deposition (CVD) techniques can be used to form the layers in any of the methods of the present teaching.

A handling wafer 210 is attached to the first distributed Bragg reflector 104. The handling wafer 210 can be a semiconductor wafer or any one of numerous other types of wafers or substrates that are compatible with high temperature fusion bonding. The handling wafer 210 can be attached with any one of various types of polymers that are stable at high temperature. For example, the handling wafer 210 can be attached with polyimide. The handling wafer 210 is used to secure the first half 202 of the tunable optical filter 100 for additional processing.

The handling wafer 210 is used to support the first half 202 of the tunable optical filter 100 during lapping. The entire silicon substrate 208 is removed from the first half 202 of the tunable optical filter 100 during the lapping process. The buried oxide layer 206 is then chemically trimmed to a buried oxide layer 206′ that is one half of a quarter wavelength thick. The first half 202 of the tunable optical filter 100 is then prepared for fusion bonding.

The second half 204 of the tunable optical filter 100 is formed by anodically bonding a single crystalline heater layer 110 on top of a glass substrate 112. All of the methods of the present teaching include forming an electrical contact to the single crystalline heater 110. There are numerous ways of contacting the single crystalline heater 110 with an electrode, such as forming an electrical contact before further processing or etching material to the top or bottom of the single crystalline heater 110. The second distributed Bragg reflector 108 is then deposited on top of the single crystalline heater layer 110. The second distributed Bragg reflector 108 is formed of dielectric materials that will be stable during the high temperature fusion bonding process. For example, the second distributed Bragg reflector 108 can be formed of alternating layers of silicon oxide, silicon nitride, and silicon oxynitride. Physical vapor deposition (PVD) or chemical vapor deposition (CVD) techniques can be used to form the layers in any of the methods of the present teaching.

One half of a quarter wavelength of oxide 212 is then formed on the second distributed Bragg reflector 108. For example, the one half of a quarter wavelength of oxide 212 can be deposited by CVD or PVD. One skilled in the art will appreciate that a quarter wavelength of numerous other types of dielectric material can be used between the single-crystalline silicon cavity 102 and the second distributed Bragg reflector 108 in any of the methods of the present teaching.

The first 202 and the second half 204 of the tunable optical filter 100 are then fusion bonded together at high heat and high pressure. The fusion bonding process according to the present teaching includes a surface treatment that can include chemical and/or mechanical polishing and standard Piranha/RCA cleaning. The fusion bonding process also includes pre-bonding, and post-bonding annealing steps. Fusion bonding results in the formation of a cavity with a highly stable refractive index because hydrogen and other gases more completely outgas from the cavity with the higher processing temperatures.

After the fusion bonding, the one half of the quarter wave length buried oxide layer 206′ on the bottom of the single-crystalline silicon cavity 102 and the one half of the quarter wave length oxide layer 212 formed on top of the second distributed Bragg reflector 108 are fused together to form a one quarter wavelength oxide layer 106 that attaches the first 202 and second half 204 of the tunable optical filter 100 together. The handling wafer 210 is then removed.

FIG. 2B illustrates another process 250 for fabricating the thermally tunable Fabry-Perot optical filter 100 with the single-crystalline silicon cavity 102 that was described in connection with FIG. 1A. Referring to both FIGS. 1A and 2B, the single-crystalline silicon cavity 102 is formed on a first half 252 of the tunable optical filter 100 and the single crystalline heater 110 and the second distributed Bragg reflector 108 are formed on a second half 254 of the tunable optical filter 100. The first 252 and the second half 254 of the thermally tunable Fabry-Perot optical filter 100 are then fusion bonded together at high temperature and high pressure. The first distributed Bragg reflector 104 is deposited after the fusion bonding to complete the filter structure.

More specifically, the first half 252 of the tunable optical filter 100 is formed by providing a silicon substrate 258 with a buried oxide layer 256 and a single crystal silicon layer. The single-crystalline silicon layer forms the cavity 102. One half of a quarter wavelength of oxide 260 is grown on top of the single-crystalline silicon cavity 102.

The second half 254 of the tunable optical filter 100 is formed by anodically bonding a single crystalline heater layer 110 on top of a glass substrate 112. The second distributed Bragg reflector 108 is then deposited on top of the single crystalline heater layer 110. The second distributed Bragg reflector 108 is formed of dielectric materials that will be stable during the high temperature fusion bonding process. For example, the second distributed Bragg reflector 108 can be formed of alternating layers of silicon oxide, silicon nitride, and silicon oxynitride. One half of a quarter wavelength of oxide 262 is then grown on the second distributed Bragg reflector 108. For example, the one half of a quarter wavelength of oxide 262 can be grown by chemical vapor deposition.

The first 252 and the second half 254 of the tunable optical filter 100 are then fusion bonded together at high heat and high pressure. The one half of the quarter wave length oxide layer 260 on the single-crystalline silicon cavity 102 and the one half of the quarter wave length oxide layer 262 formed on top the second distributed Bragg reflector 108 are fused together to form a one quarter wavelength oxide layer 106 that attaches the first 252 and second half 254 of the tunable optical filter 100 together. One skilled in the art will appreciate that a quarter wavelength of numerous other types of dielectric material can be used between the single-crystalline silicon cavity 102 and the second distributed Bragg reflector 108.

After the high temperature fusion bonding, the device is lapped. A handling wafer (not shown) can be bonded to the glass 112 substrate to support the substrate during lapping. The entire silicon substrate 258 is removed during the lapping process. The buried oxide layer 256 is then chemically removed exposing the single-crystalline silicon cavity 102. The first distributed Bragg reflector 104 is then deposited on top of the single-crystalline silicon cavity 102. The first distributed Bragg reflector 104 can be formed of numerous types of low and high index materials. The first distributed Bragg reflector 104 does not need to be formed of materials that are stable at high temperatures because the first distributed Bragg reflector 104 is formed after the high temperature fusion bonding.

FIG. 2C illustrates another process 280 for fabricating the thermally tunable Fabry-Perot optical filter 100 with the single-crystalline silicon cavity 102 that was described in connection with FIG. 1A. Referring to both FIGS. 1A and 2C, the single-crystalline silicon cavity 102 and the first distributed Bragg reflector 104 are formed on a first half 282 of the tunable optical filter 100 and the single crystalline heater 110 and the second distributed Bragg reflector 108 are formed on a second half 284 of the tunable optical filter 100. The first 282 and the second half 284 of the thermally tunable Fabry-Perot optical filter 100 are then fusion bonded together at high temperature and high pressure.

More specifically, the first half 282 of the tunable optical filter 100 is formed by providing a silicon substrate 288 with a buried oxide layer 286 and a single crystal silicon layer. The single-crystalline silicon layer forms the cavity 102. The first distributed Bragg reflector 104 is then deposited on top of the single-crystalline silicon cavity 102. The first distributed Bragg reflector 104 is formed of dielectric materials that will be stable during the high temperature fusion bonding process. A handling wafer 290 is attached to the first distributed Bragg reflector 104.

The handling wafer 290 is used to support the first half 282 of the tunable optical filter 100 during lapping. The entire silicon substrate 288 is removed from the first half 282 of the tunable optical filter 100 during the lapping process. The buried oxide layer 286 is then chemically removed to expose the single-crystalline silicon cavity 102.

The second half 284 of the tunable optical filter 100 is formed by anodically bonding a single crystalline heater layer 110 on top of a glass substrate 112. The second distributed Bragg reflector 108 is then deposited on top of the single crystalline heater layer 110. The second distributed Bragg reflector 108 is formed of dielectric materials that will be stable during the high temperature fusion bonding process. For example, the second distributed Bragg reflector 108 can be formed of alternating layers of silicon oxide, silicon nitride, and silicon oxynitride. A quarter wavelength of oxide 106 is then grown on the second distributed Bragg reflector 108. For example, the quarter wavelength of oxide 106 can be grown by CVD or PVD. One skilled in the art will appreciate that a quarter wavelength of numerous other types of dielectric material can be used between the single-crystalline silicon cavity 102 and the second distributed Bragg reflector 108.

The first 282 and the second half 284 of the tunable optical filter 100 are then fusion bonded together at high heat and high pressure. After the high temperature fusion bonding, the device is lapped. The entire handling substrate 290 is removed during the lapping process.

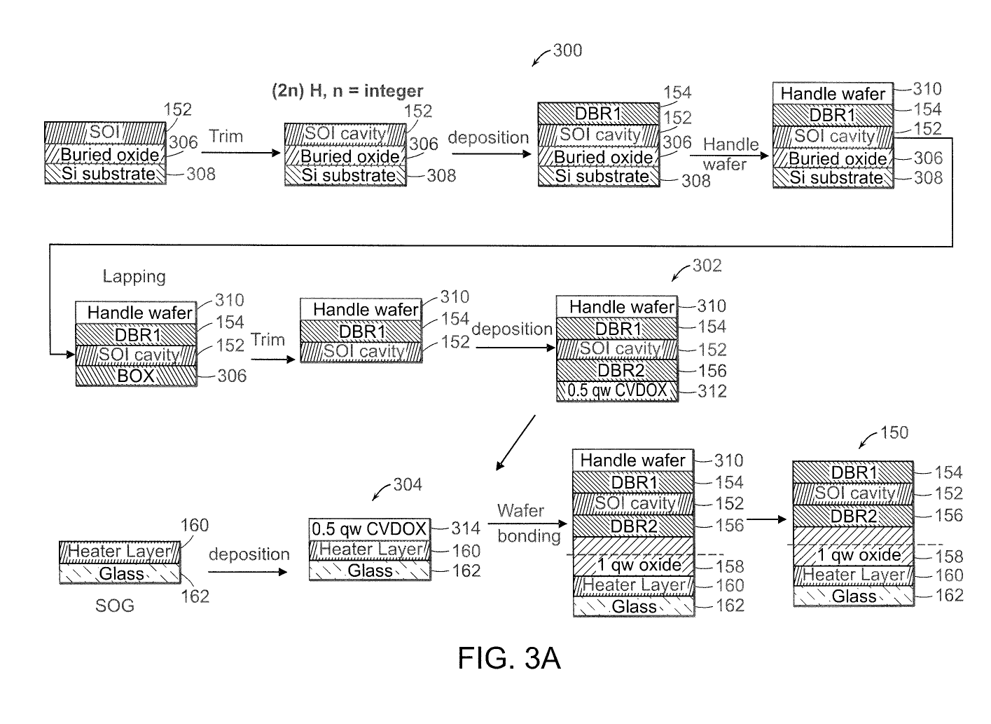

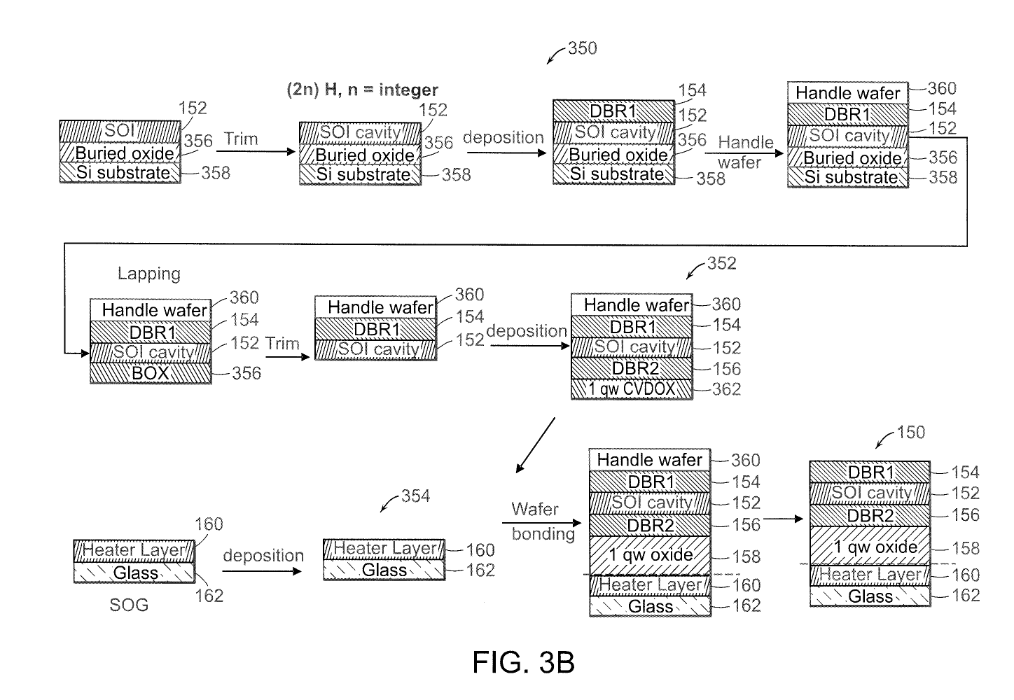

FIG. 3A illustrates a process 300 for fabricating the thermally tunable Fabry-Perot optical filter 150 with the single-crystalline silicon cavity 152 that was described in connection with FIG. 1B. Referring to both FIGS. 1B and 3A, in this process, the single-crystalline silicon cavity 152 and both the first and second distributed Bragg reflector 154, 156 are formed on a first half 302 of the tunable optical filter 150 and the single crystalline heater 160 is formed on a second half 304 of the tunable optical filter 150. The first 302 and the second half 304 of the thermally tunable Fabry-Perot optical filter 150 are then fusion bonded together at high temperature and high pressure.

More specifically, the first half 302 of the tunable optical filter 150 is formed by providing a silicon substrate 308 with a buried oxide layer 306 and a single crystal silicon layer. The single-crystalline silicon layer forms the cavity 152. The first distributed Bragg reflector 154 is then deposited on top of the single-crystalline silicon cavity 152. The first distributed Bragg reflector 154 is formed of dielectric materials that will be stable during the high temperature fusion bonding process. For example, the first distributed Bragg reflector 154 can be formed of alternating layers of silicon oxide, silicon nitride, and silicon oxynitride.

A handling wafer 310, which can be a semiconductor wafer or any one of numerous other types of wafers or substrates, is attached to the first distributed Bragg reflector 154. The handling wafer 310 can be attached with various types of polymers that are stable at high temperature, such as polyimide. The handling wafer 310 is used to secure the first half 302 of the tunable optical filter 150 for additional processing.

The silicon substrate 308 is then lapped. The handling wafer 310 is used to support the first half 302 of the tunable optical filter 150 during lapping. The entire silicon substrate 308 is removed during the lapping process. The buried oxide layer 306 is then chemically removed exposing the single-crystalline silicon cavity 152. The second distributed Bragg reflector 156 is then deposited on the bottom of the single-crystalline silicon cavity 152. The second distributed Bragg reflector 156 is formed of dielectric materials that will be stable during the high temperature fusion bonding process. For example, the second distributed Bragg reflector 156 can be formed of alternating layers of silicon oxide, silicon nitride, and silicon oxynitride. One half of a quarter wavelength of silicon dioxide 312 is then deposited on the bottom of the second distributed Bragg reflector 156.

The second half 304 of the tunable optical filter 150 is formed by anodically bonding a single crystalline heater layer 160 on top of a glass substrate 112. A half of a quarter wavelength of oxide 314 is then grown on the single crystalline heater layer 160. For example, the half of a quarter wavelength of oxide 314 can be grown by chemical vapor deposition.

The first 302 and the second half 304 of the tunable optical filter 150 are then fusion bonded together at high heat and high pressure. After the fusion bonding, the one half of the quarter wave length oxide layer 312 on the bottom of the second distributed Bragg reflector 156 and the one half of the quarter wave length oxide layer 314 formed on top of the single crystalline heater layer 160 are fused together to form a one quarter wavelength oxide layer 158 that attaches the first 302 and second half 304 of the tunable optical filter 150 together. The handling wafer 310 is then removed.

FIG. 3B illustrates another process 350 for fabricating the thermally tunable Fabry-Perot optical filter 150 with the single-crystalline silicon cavity 152 that was described in connection with FIG. 1B. The process 350 is similar to the process 300 that was described in connection with FIG. 3A. Referring to both FIGS. 1B and 3B, in this process, the single-crystalline silicon cavity 152 and the first distributed Bragg reflector 154 are formed on a first half 352 of the tunable optical filter 150 and the single crystalline heater 160 and the second distributed Bragg reflector 156 is formed on a second half 354 of the tunable optical filter 150. The first 352 and the second half 354 of the thermally tunable Fabry-Perot optical filter 150 are then fusion bonded together at high temperature and high pressure.

More specifically, the first half 352 of the tunable optical filter 150 is formed by providing a silicon substrate 358 with a buried oxide layer 356 and a single crystal silicon layer. The single-crystalline silicon layer forms the cavity 152. The first distributed Bragg reflector 154 is then deposited on top of the single-crystalline silicon cavity 152. The first distributed Bragg reflector 154 is formed of dielectric materials that will be stable during the high temperature fusion bonding process. For example, the first distributed Bragg reflector 154 can be formed of alternating layers of silicon oxide, silicon nitride, and silicon oxynitride.

A handling wafer 360, which can be a semiconductor wafer or any one of numerous other types of wafers or substrates, is attached to the first distributed Bragg reflector 154. The handling wafer 360 can be attached with various types of polymers that are stable at high temperature, such as polyimide. The handling wafer 360 is used to secure the first half 352 of the tunable optical filter 150 for additional processing.

The silicon substrate 358 is then lapped. The handling wafer 360 is used to support the first half 352 of the tunable optical filter 150 during lapping. The entire silicon substrate 358 is removed during the lapping process. The buried oxide layer 356 is then chemically removed exposing the single-crystalline silicon cavity 152. The second distributed Bragg reflector 156 is then deposited on the bottom of the single-crystalline silicon cavity 152. The second distributed Bragg reflector 156 is formed of dielectric materials that will be stable during the high temperature fusion bonding process. For example, the second distributed Bragg reflector 156 can be formed of alternating layers of silicon oxide, silicon nitride, and silicon oxynitride. One half of a quarter wavelength of silicon dioxide 362 is then grown on the bottom of the second distributed Bragg reflector 156.

The second half 354 of the tunable optical filter 150 is formed by anodically bonding a single crystalline heater layer 160 on top of a glass substrate 162. The first 352 and the second half 354 of the tunable optical filter 150 are then fusion bonded together at high heat and high pressure. After the fusion bonding, the handling wafer is removed by mechanical or chemical processes.

Thus, there are numerous methods of manufacturing tunable optical filters according to the present invention. The methods of the present teaching use high quality single crystalline (c-Si) silicon cavities or numerous other types of cavity materials. Also, these methods allow the use of highly reliable single crystalline sheet resistance heater layer structure. Also, the methods allow precise trimming of the cavity thickness. In addition, the methods allow for batch process and the methods are highly scalable to large diameter wafers.

In addition, the methods of the present teaching use high temperature fusion bonding of the two halves of the device. Fusion bonding results in a very strong bond that is highly stable and reliable. Fusion boding also results in a highly stable index of refraction. No amorphous silicon is used in the distributed Bragg reflector layers in the tunable optical filters. Amorphous silicon distributed Bragg reflector layers are undesirable because they are less reliable than silicon dioxide/silicon nitride Bragg reflecting layers.

The resulting tunable optical filter according to the present teaching that includes a single-crystalline silicon cavity, or other types of cavity materials stable at bonding temperatures, which is fusion bonded to the single crystalline sheet resistance heater layer has several advantages over known filters. One advantage is that the tunable optical filter is more mechanical stability and reliability than known thin membrane filters. Another advantage is that the cavity thickness and the corresponding free spectral range can be optimized to achieve the maximum thermal tunability for specific wavelength applications. Another advantage is that the stability of the cavity is improved because the refractive index of the cavity material is highly stable since the cavity is formed of crystalline material and because the hydrogen more completely outgassed with the fusion bonding.

### EQUIVALENTS

While the applicant's teachings are described in conjunction with various embodiments, it is not intended that the applicant's teachings be limited to such embodiments. On the contrary, the applicant's teachings encompass various alternatives, modifications, and equivalents, as will be appreciated by those of skill in the art, which may be made therein without departing from the spirit and scope of the teachings.

What is claimed is:

1. A thermally tunable Fabry-Perot optical filter comprising:
a. a single crystalline sheet resistance heater layer;
b. a single crystalline semiconductor spacer layer positioned proximate to and in thermal communication with the single crystalline sheet resistance heater layer;
c. a first distributed Bragg reflector positioned proximate to a first surface of the single crystalline semiconductor spacer layer; and
d. a second distributed Bragg reflector positioned proximate to a second surface of the single crystalline semiconductor spacer layer.

2. The optical filter of claim 1 wherein the single crystalline semiconductor spacer layer comprises single crystalline (c-Si) silicon.

3. The optical filter of claim 1 wherein the single crystalline semiconductor spacer layer comprises single crystalline germanium.

4. The optical filter of claim 1 wherein the single crystalline semiconductor spacer layer comprises a III-V semiconductor.

5. The optical filter of claim 1 wherein the single crystalline semiconductor spacer layer comprises a II-VI semiconductor.

6. The optical filter of claim 1 wherein the first and second distributed Bragg reflector comprise alternating layers of at least two of silicon oxide, silicon nitride, and silicon oxynitride.

7. The optical filter of claim 1 wherein the single crystalline sheet resistance heater layer is positioned adjacent to the single crystalline semiconductor spacer layer in a vertical direction.

8. The optical filter of claim 1 wherein the single crystalline sheet resistance heater layer is positioned co-planar with the single crystalline semiconductor spacer layer.

9. The optical filter of claim 8 wherein the single crystalline sheet resistance heater layer is a doped region of the single crystalline semiconductor spacer layer.

10. The optical filter of claim 8 wherein the single crystalline sheet resistance heater layer is integrated into the single crystalline semiconductor spacer layer.

11. The optical filter of claim 1 wherein the thermally tunable Fabry-Perot optical filter is formed on a glass substrate.

12. The optical filter of claim 1 wherein a first and second portion of the thermally tunable Fabry-Perot optical filter are fusion bonded.

13. A thermally tunable Fabry-Perot optical filter comprising:
a. a single crystalline sheet resistance heater layer;
b. a spacer layer positioned proximate to and in thermal communication with the single crystalline sheet resistance heater layer, wherein the spacer layer has a thermo-optic coefficient greater than 10⁻⁴, is substantially optical transparent to optical signals being filtered, and is thermally stable during fabrication;
c. a first distributed Bragg reflector positioned proximate to a first surface of the spacer layer; and
d. a second distributed Bragg reflector positioned proximate to a second surface of the spacer layer.

14. The optical filter of claim 13 wherein the spacer layer comprises a polymer.

15. The optical filter of claim 13 wherein the spacer layer comprises a single crystal material.

16. The optical filter of claim 13 wherein the first and second distributed Bragg reflectors comprise alternating layers of at least two of silicon oxide, silicon nitride, and silicon oxynitride.

17. The optical filter of claim 13 wherein the single crystalline sheet resistance heater layer is positioned adjacent to the spacer layer in a vertical direction.

18. The optical filter of claim 13 wherein the single crystalline sheet resistance heater layer is positioned co-planar with the spacer layer.

19. The optical filter of claim 13 wherein the single crystalline sheet resistance heater layer is integrated into the spacer layer.

20. The optical filter of claim 13 wherein the thermally tunable Fabry-Perot optical filter is formed on a glass substrate.

21. The optical filter of claim 13 wherein a first and second portion of the thermally tunable Fabry-Perot optical filter are fusion bonded.

22. A method of fabricating a thermally tunable Fabry-Perot optical filter, the method comprising:
a. forming a single-crystalline semiconductor cavity on a first half section of the Fabry-Perot optical filter;
b. depositing a first distributed Bragg reflector on the first half section of the tunable optical filter;
c. forming a single crystalline heater on a second half section of the tunable optical filter;
d. depositing a second distributed Bragg reflector on the second half section of the tunable optical filter; and
e. fusion bonding the first and second half sections of the thermally tunable Fabry-Perot optical filter together, thereby forming the Fabry-Perot optical filter.

23. The method of claim 22 further comprising forming one half of a quarter wavelength of dielectric material on each of the first and second half sections of the thermally tunable Fabry-Perot optical filter prior to fusion bonding.

24. The method of claim 22 further comprising forming a quarter wavelength of dielectric material on the second half section of the thermally tunable Fabry-Perot optical filter cavity prior to fusion bonding.

25. The method of claim 22 wherein the semiconductor comprises single crystalline (c-Si) silicon.

26. A method of fabricating a thermally tunable Fabry-Perot optical filter, the method comprising:
a. forming a single-crystalline semiconductor cavity on a first half section of the Fabry-Perot optical filter;
b. forming a single crystalline heater on a second half section of the tunable optical filter;
c. depositing a second distributed Bragg reflector on the second half section of the tunable optical filter;
d. fusion bonding the first and second half sections of the thermally tunable Fabry-Perot optical filter together; and
e. depositing a first Bragg reflector on the single-crystalline semiconductor cavity, thereby forming the Fabry-Perot optical filter.

27. The method of claim 26 further comprising forming one half of a quarter wavelength of dielectric material on each of the first and second half sections of the thermally tunable Fabry-Perot optical filter prior to fusion bonding.

28. The method of claim 26 wherein the semiconductor comprises single crystalline (c-Si) silicon.

29. A method of fabricating a thermally tunable Fabry-Perot optical filter, the method comprising:
a. forming a single-crystalline semiconductor cavity on a first half section of the Fabry-Perot optical filter;
b. depositing a first distributed Bragg reflector on a first surface of the single-crystalline semiconductor cavity;
c. depositing a second distributed Bragg reflector on a second surface of the single-crystalline semiconductor cavity;
d. forming a single crystalline heater on a second half section of the tunable optical filter; and
e. fusion bonding the first and second half sections of the thermally tunable Fabry-Perot optical filter together.

30. The method of claim 29 further comprising forming one half of a quarter wavelength of dielectric material on each of the first and second half sections of the Fabry-Perot optical filter prior to fusion bonding.

31. The method of claim 29 further comprising forming a quarter wavelength of dielectric material on the first half of the Fabry-Perot optical filter cavity prior to fusion bonding.

32. The method of claim 29 wherein the semiconductor comprises single crystalline (c-Si) silicon.

33. A method of fabricating a thermally tunable Fabry-Perot optical filter, the method comprising:
a. forming a single-crystalline semiconductor cavity;
b. forming at least one single crystalline heater adjacent to the single-crystalline semiconductor cavity in a co-planar direction;
c. depositing a first distributed Bragg reflector on a first surface of the co-planar single-crystalline semiconductor cavity and the at least one single crystalline heater;
d. depositing a quarter wavelength of dielectric material on the co-planar single-crystalline semiconductor cavity and the at least one single crystalline heater; and
e. depositing a second distributed Bragg reflector on the quarter wavelength of dielectric material.

34. The optical filter of claim 33 wherein the semiconductor comprises single crystalline (c-Si) silicon.
